(19) United States
(12) Patent Application Publication
(10) Pub. No.: US 2011/0129229 A1
(43) Pub. Date: Jun. 2, 2011

(54) OPTICAL RECEIVER DEVICE

(75) Inventor: Marcel F. Schemmann, Marie Hoop (NL)

(73) Assignee: FOCE Technology Internatioal BV, Marie Hoop (NL)

(21) Appl. No.: 13/055,967

(22) PCT Filed: Jul. 27, 2009
(86) PCT No.: PCT/IB09/06371

§ 371 Date: Jan. 26, 2011

Related U.S. Application Data
(60) Provisional application No. 61/083,926, filed on Jul. 26, 2008.

(51) Int. Cl. H04B 10/12; H04B 10/06; H04B 10/02

(52) U.S. Cl. 398/137; 398/202; 398/141

(57) ABSTRACT

In a receiver suitable for an optical fiber link and comprising an optical receiver unit (1), which includes a radiation-sensitive detector (4) and a signal processing circuit (6,8), and an electrical receiver unit (2), the optical receiver unit comprises a power draining circuit (16) that drains power from a pull-up stage (R₁-R₄; Vpu) of the electrical receiver unit and supplies power to the electrical circuit of the optical receiver unit.

### BACKGROUND ART

European patent application EP 07105438.1 describes a new type of fiber optical link, which shows an optimum balance between power consumption and data transmission rate capacity. This fiber optical link has unconventional low power consumption and thus is suitable, not only for consumer application, but also for other applications as described in said previous patent application. The low power consumption is the result of a new design of the transmitter and receiver such that both operate in a first, high-power/high-speed, mode and a second, low-power/low-speed mode.

The high-speed mode in understood to mean the mode wherein (high data rate) information signals, for example a digital color television signal, are transmitted at a data bit rate larger than 100 megabit per second, hereinafter Mbs. In this mode the transmitter's radiation source, usually a diode laser operates at full power and the emitted radiation is modulated at high frequency by means of a laser driver. This driver that includes an amplifier consumes relatively much power. The low-speed mode is understood to mean the mode wherein (low data rate) signals are transmitted at a data bit rate smaller than 10 Mbs. In this mode, which includes a standby mode, the high-power driver is off, i.e. inactive, and the laser itself consumes little power. In this way an optical link is obtained wherein the power consumption is reduced to a minimum, i.e. it is not larger than necessary for the momentarily required functionality.

Although designed for signals having a DVI (digital visual interface) or HDMI (high-density multimedia interface) format, also signals having another, existing or future, format can be transmitted by means of this optical link. The optical link is not only suitable for consumer apparatuses, but it can also be used in other environments such as protected monumental buildings wherein walls and ceilings should be kept in their original state, in hospitals wherein wireless communication is not allowed, and in factories for communication between machines and between parts of one machine. Generally, the optical link can be used in all circumstances wherein large amounts of information should be transmitted and information is encoded by means of encoding protocols.

At the receiver side the optical link includes a radiation-sensitive detector, usually a photo diode, and an electronic circuit for processing the electrical signals from the detector. At this side an amplifier is needed for obtaining a suitable signal. This amplifier and also the data processing circuitry require electrical power. In envisaged applications no power or only limited power is available. This would mean that the optical link does not function without an external power source at the receiver side, which would detract the attractiveness of the power saving fiber optical link.

### DESCRIPTION OF DRAWINGS

These and other aspects of the invention will be apparent from and elucidated by way of non-limitative example with reference to the embodiments described hereinafter. In the drawings:

FIG. 1 shows a diagram of a conventional receiver for optical signals;

FIG. 2 shows a receiver according to the invention wherein the optical receiver is provided with a power draining circuit;

FIG. 3 shows such a receiver wherein the optical receiver also includes a power storage component;

FIG. 4 shows such a receiver wherein the optical receiver also includes a transmitter laser and associated circuit;

FIG. 5 shows an embodiment of a pull-up stage of an electrical receiver;

FIG. 6 shows sub-signals of a high-level differential data signal to be supplied to the electrical receiver;

FIG. 7 shows sub-signals of a low-level differential data signal to be supplied to the optical receiver;

FIG. 8 shows the high-level differential signal composed of the sub-signals of FIG. 6;

FIG. 9 shows a pull-up stage with electrical current sources;

FIG. 10 shows a first embodiment of current source implementation;

FIG. 11 shows a second embodiment of such implementation;

FIG. 12 shows an embodiment of a circuit for an optical receiver provided with an energy storage component;

FIG. 13 shows an embodiment of a circuit that allows operation of a low-speed optical link in both a basic mode and in a higher multiplexed mode;

FIG. 14 shows a first embodiment of a pull-up stage without current sources;

FIG. 15 shows a second embodiment o such a stage and

FIG. 16 shows a diagram of a fiber optical link

In these Figures the same elements are designated by the same reference numerals.

### MODES AND INDUSTRIAL APPLICABILITY

The following description relates to a receiver for optical signals that includes an optical receiver unit and an electrical receiver unit, which optical receiver unit comprises a radiation sensitive detector for converting an optical signal into an electrical signal and an electronic circuit for processing the electrical signal.

Also described is a fiber optical link provided with such a receiver.

The receiver may be used in a fiber optical link for transmitting digital data from a first apparatus to a second apparatus. A fiber optical link for consumer, i.e. mass-, apparatuses should not only have a simple and cheap construction, also its power consumption should be low.

In the following description, devices and techniques are described to help solve the problems described in the Background, and to provide a receiver for optical signals that functions without an external power source. This receiver is characterized in that the optical receiver unit comprises a power drain circuit that drains power from a pull-up stage of the electrical receiver unit and supplies power to the electrical circuit of the optical receiver unit

Electrical power for the optical receiver can be drawn from the pull-up stage, or input termination, of the electrical receiver without detrimentally affecting the data signal being transmitted. Employing a fiber optical link, such as a link for HDMI format signals, bulky external power supplies at the optical receiver side may no longer be needed.

A receiver that has a high-speed mode and a low-speed mode is preferably further characterized in that the electrical receiver unit includes a first pull-up stage for high-speed signals and a second pull-up stage for low speed signals, both stages being coupled to the power draining circuit and comprising a voltage source and at least one pull-up resistor.

This allows turning of the high-speed pull-up stage when it is not needed, i.e. when no high-speed data signal have to be transferred.

To meet the requirement that the current drawn from the pull-up stage allows powering of the optical receiver circuitry also in case this current is relatively small, the receiver may be further characterized in that the optical receiver unit comprises a power storage component, which receives a current from the power draining circuit.

The power storage component, for instance a battery or a capacitor, is loaded by a small current and supplies the collected power only when it is needed. Thus power supply is warranted also in case pull-up voltages are not always present or cannot supply sufficient power to instantaneously power the optical receiver circuit.

A receiver that is suitable for an optical link having bi-directional low-speed signal transfer capability is characterized in that the optical receiver unit comprises an additional radiation-sensitive detector for low-speed signals and an associated electronic circuit for processing low-speed signals, which is powered from the second pull-up stage.

A receiver that is suitable for bi-directional optical communication, may be further characterized in that the optical receiver comprises a radiation source and associated electronics that is powered from the power draining circuit.

An embodiment of the receiver wherein the optical receiver unit includes line drivers circuitry for adapting the output signals is preferably characterized in that the power draining circuit is integral part of the line driver circuitry.

By providing a fiber optical link for transmitting digital data from a source apparatus to a receiver apparatus with the new receiver an optimum use can be made of the capabilities of this link.

Such a fiber optical link may be further characterized in that control means are provided for determining the state of the pull-up stage of the electrical receiver unit and for delaying transfer of control data until the pull-up stage of the electrical receiver unit can supply sufficient power to the optical receiver.

An embodiment of this fiber optical link that is suitable for bi-directional communication and wherein the transmitter and the receiver are designed to operate in a first, high-power/high-speed mode and in a second low-power/low-speed mode, may be characterized in that switching between the two modes is controlled by the voltage state of the pull-up stage.

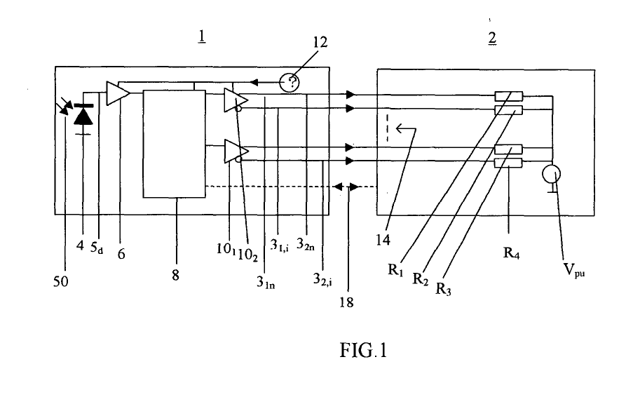

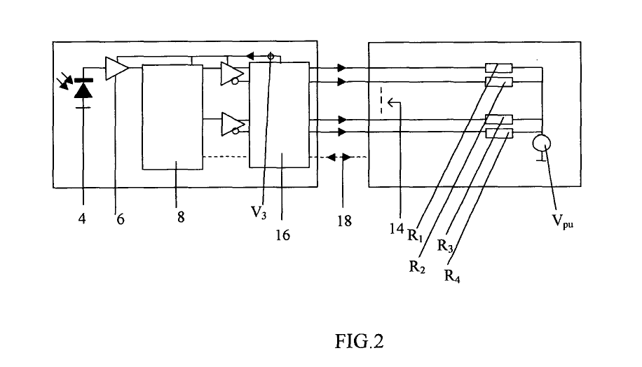

FIG. 1 shows a diagram an optical receiver 1, which comprises at least one radiation-sensitive detector 4, usually a photo diode. The detector receives an optical signal SO from for example an optical fiber, not shown. The receiver also includes an amplifier 6, usually a trans impedance amplifier (TIA), which enhances the output signal S_{d} of the photo diode to obtain a required signal to noise ratio that is needed for further signal processing. The output of amplifier 6 is connected to an electronic processing circuit 8, which is usually, but not exclusive, a logic circuit. The output signals of the optical receiver should be supplied to an electrical receiver 2 that is usually part of a receiving apparatus, such as a video display apparatus provided with a DVI or HDMI input. In order to bring the optical receiver signals to amplitude that is compatible with that used in the electrical receiver 2, the optical receiver includes line drivers 10₁ and 10₂, which convert its output signals to obtain the required adaptation. By way of example, two output signals S₁ and S₂ are shown in FIG. 2. Preferably these signals are in differential format so that the line drivers have a normal output and an inverted output, delivering signals S_{In}, S₂ₙ and signals S₁ᵢ, S₂ᵢ, respectively to the electrical receiver. For their adequate performance amplifier 6, logic circuit 8 and line drivers 10₁ and 10₂ need electrical power V_{supply} as is indicated by fictitious power source 12. This power source is labeled with a question mark, because it is not included in the optical receiver. An external power source could be used, but this is not an attractive solution as noted herein above.

An attractive solution may be devised for powering the optical receiver electronics, or circuitry. Alternative use may be made of components, which are usually present in the electrical receiver for another purpose. The electrical receiver has an internal pull-up stage, or termination stage, for pulling up a signal line to a predetermined voltage.

The pull-up stage comprises a pull-up voltage source Vpu and pull-up resistors R for each electrical line, in this embodiment thus four resistors R₁, R₂, R₃ and R₄. According to the invention the power for the optical receiver electronics is drawn from the pull-up stage of the electrical receiver by pulling an electrical current through the pull-up resistors. Powering from the pull-up terminal detrimentally affects the data signal being transferred and may be avoided. This means that the current through the pull-up resistors should be small enough to prevent the level of a signal to become too low.

For powering the optical receiver circuit a power draining circuit 16 is arranged in this receiver 1 downstream the line drivers, thus between the line drivers and the apparatus that includes the electrical receiver 2 as is shown in FIG. 2. Embodiments of circuit 16 will be described later on. Circuit 16 should draw a current through resistors R₁-R₄ without affecting data signals being transferred. For example, in case the data signal varies around a DC signal, the draining circuit 16 draws a DC current through the pull-up resistors R₁-R₄. In this way in circuit 16 a voltage is generated which functions as supply voltage Vs for the optical receiver electronics. This supply voltage will be typically smaller than the DC voltage over the pull-up resistors. If necessary the supply voltage can be converted to another voltage by means of a DC-DC convertor. Thus the optical receiver is provided with a (virtual) supply source 12 shown in FIG. 1. Preferably the power draining circuit is integral part of the line driver circuitry.

In the embodiment of FIG. 2 a data signal supplied to the electrical receiver 2 is a signal that oscillates around a DC bias. As will be described later on, an alternative embodiment may be designed such that if a signal line is in the high state, i.e. is voltage is above a tress hold voltage, it will be inactive. In that case an apparatus communicating to this line will not send signals to it. Such an apparatus has an internal switch, for example a transistor, which can set the line in the low state (voltage below the threshold voltage), i.e. make it active.

FIGS. 1 and 2 show connection, or signal line pairs, for only two differential signals. In practice more connections, for example four, may be present between the optical receiver and the electrical receiver. This is indicated in the Figures by the small vertical lines 14.

In practice additional communication between optical receiver 1 and electrical receiver 2 may be required, as indicated by dashed line 18 with two arrows. Logic circuit 8 manages also this communication, which requires additional power. Also this power can be furnished by the supply voltage Vs generated by power draining circuit 16.

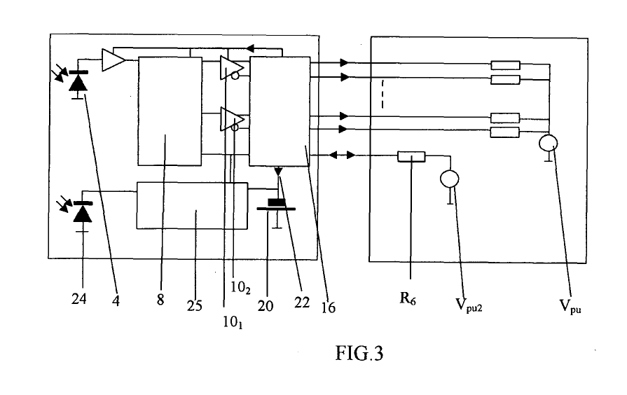

Under circumstances the electrical current that can be drawn through the pull-up resistors safely, i.e. without disturbing the data signals too much, may be too small to continuously supply sufficient power to the optical receiver circuitry. According to the invention and as shown in FIG. 3, this problem can be solved by arranging a power storage component 20, such as a battery or a capacitor in the optical receiver unit. The storage component is loaded by the small current that can be safely drawn through the pull up resistors.

For a regular open collector or open drain circuit a high level is detected on a signal line as long as the voltage on that line is sufficient high, i.e. the line is passive. The line voltage can be pulled low, i.e. the line can be made active, for example to ground, by any apparatus connected to that line by means of a switch or transistor in the apparatus. Then all apparatuses connected to the same line will detect a low level. The amount of current that can be drawn safely through a pull-up resistor is limited by the requirement that the voltage drop on the line caused by this current is such small that the line voltage will remain high enough to allow reliable high-level signaling. This current is supplied to the storage component via the power drain circuit 16, as is indicated by arrow 22. The power stored in the storage device 20 is supplied to the optical receiver electronics only when it is needed, i.e. when this receiver has to process data. Ways to realize this will be discussed later on. Use of a storage component and selectively supplying its power to the electronics is especially, but not exclusive suitable in case the data stream format is such that the pull-up output is high most of the time.

As already remarked, the fiber optical link described in previous patent application EP 07105438.1 can operate in two modes: a high-power/high speed mode and a low-power/low-speed mode. The optical receiver 1 for such optical fiber links has also a low-speed mode wherein only low-speed signals are received. As FIG. 3 shows the optical receiver may comprise a separate radiation-sensitive detector 24, for example a photo diode, forming part of a separate and low-speed link, or low-speed data channel. If the low-speed data is transferred via such a channel to the apparatus comprising the electrical receiver 2, the logic circuit 8, amplifier 6 and line drivers 10, which all are intended for high-speed data transfer, need not to be not active. This does occur in practical situations wherein the high-speed mode is switched off when it is not required. The pull-up voltage source Vpu can then be switched off, provided that the electrical receiver 2 includes a second pull-up voltage source Vpu₂ and an associated pull-up resistor R₅, which belong to the low-speed data channel. Power draining circuit 16 draws an electrical current through pull-up resistor R₅, which generally has high impedance. This will provide the power required for the low-speed mode. The low speed channel comprises also an amplifier and a logic circuit for processing low-speed signals. In FIG. 3 these components are included in box 25.

If the current from the second pull-up stage is not sufficient for continuously powering the low-speed electronics, this current can be stored in storage component 20 such that sufficient power is available for low-speed data transfer, which usually is a burst type of transfer.

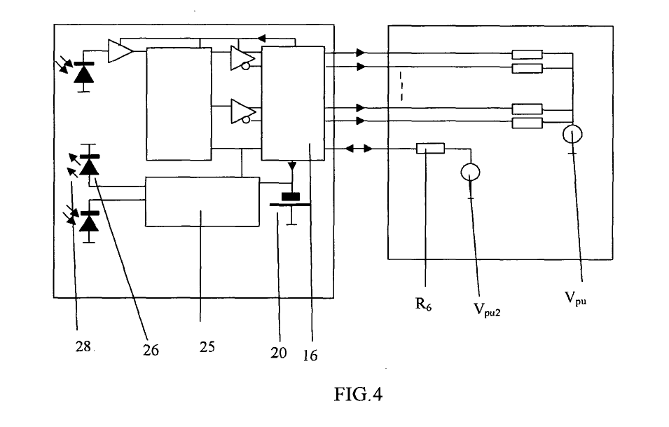

The fiber optical link discussed herein above may have an optical return path so that it allows bi-directional optical communication. An embodiment of the new receiver that is adapted to this feature is shown in FIG. 4. This embodiment comprises a radiation source 26, preferably a diode laser, for sending bursts of optical data 28 in a low-speed return path so to the other apparatus coupled to the optical link. Also diode laser 26 can be powered by means of power draining circuit 16 via electronics box 24. This box then includes laser driver circuitry.

The low-speed return path may operate in two sub-modes. In a first sub-mode basic communication is performed. In this sub-mode pull-up voltage source Vpu2 is not active and is not expected to become active soon. In a practical optical link, for example a HDMI link, in the basic communication sub-mode remote control data (CEC data) is transferred. Because this type of information is needed only during a small portion of the total communication time, it is very suitable for the concept of powering by means of the power storage component 20. The first sub-mode of communication can be designed such that minimum power is consumed. In the second sub-mode higher-speed operation is performed and several low-speed signals can be multiplexed. For instance, in this sub-mode display data (DDS data) may be sent into the optical link by multiplexing it with CEC and possible other data. Power consumption in the second sub-mode is significantly larger than in the first sub-mode. However, since DDS data is generally transferred in a short burst of activity and most of the time not present even the second sub-mode is suitable for the concept of powering by means of the power storage component 20. However, as long as pull-up voltage source Vpu is not active no transfer of images is expected. Transfer of DDS data may be held off, or delayed, until this voltage source is active and more power becomes available.

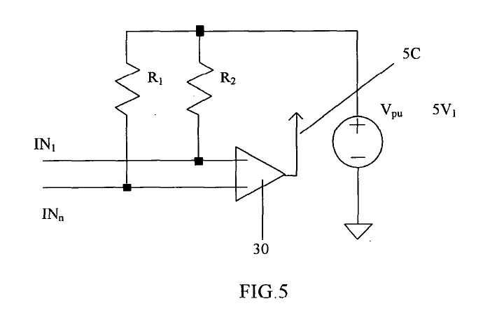

FIG. 5 shows an embodiment of the input of an electrical receiver for a high-speed differential signal, which input has pull-up capability that is provided by voltage supply Vpu and pull-up resistors. Since the signal is a differential one, two input lines are provided: a normal signal line INn and an inverted signal line INi as well as two pull-up resistors R₁ and R₂. In a practical example the supply voltage SV₁ has a value of 3.3V and the resistance value of the two resistors is 50 Ohm. The input lines are connected to the inputs of a comparator 30, which supplies a binary data output signal SC. This output signal will be high if the inverted signal is larger than the normal signal and will be low if the inverted signal is smaller than the normal signal.

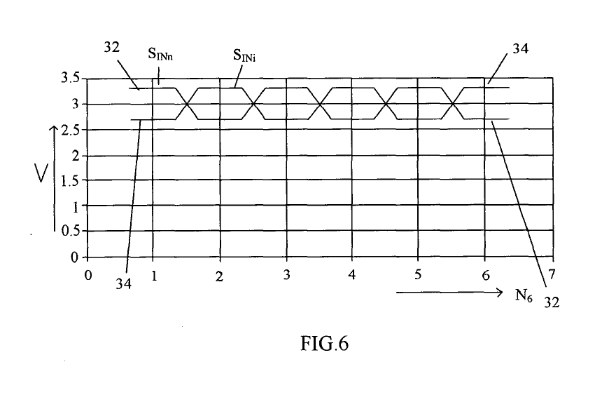

Differential electrical receivers perform well in a wide voltage range in both modes, i.e. the high-speed mode and the low-speed mode. The receivers also perform well at low signal amplitude, i.e. amplitude that is substantially smaller than the supply voltage. As an example, FIG. 6 shows the variation of a valid differential input signal having a high data signal level as a function of time, which is expressed here in terms of received data bits (Nb). Graph 32 and graph 34 represent the normal input signal S_{INn} and the inverse input signal S_{INi}, respectively. The unit for these signals is Volt. For the high signal level each signal varies between 2.7 V and 3.3 V and the average signal value is approximately 3V. The average value of the current drawn through each of the pull-up resistor R₁, R₂ is of the order of 5 mA. At any time at least 2.7 V is available at the data inputs (INn, INi in FIG. 5).

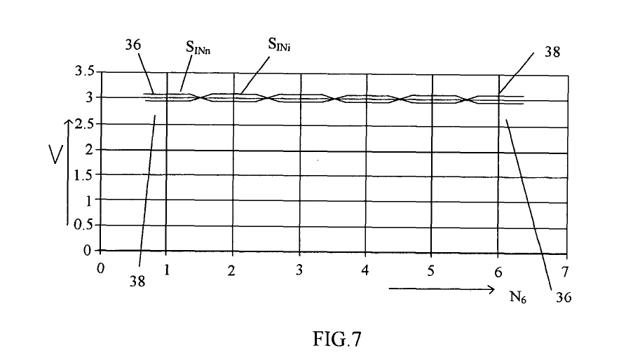

FIG. 7 shows an example of a differential input signal S_{INn}′, S_{INi}′ that is similar to that of FIG. 6, but has a low data signal level. Even for the low signal level, the average signal value is still 3 V. Thus the pull-up resistors still provide an average current of 5 mA.

FIGS. 6 and 7 also show that the receiver decision moments, i.e. points 1, 2, 3 etc on the horizontal axis are centered between the data transitions, as is typically the case in high-speed receivers.

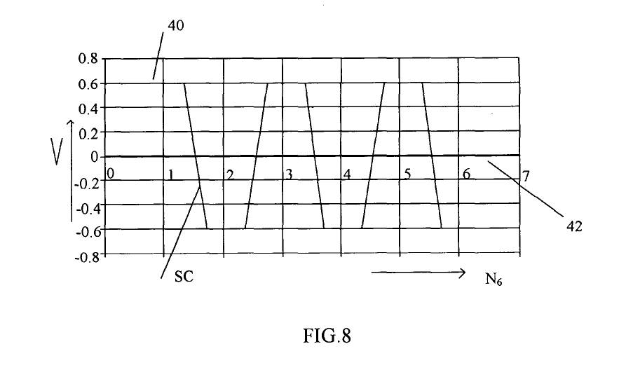

FIG. 8 shows the differential signal in the electrical receiver (signal SC in FIG. 5) for the high level signal of FIG. 6 on the same time scale. The signal SC (graph 40) varies between +0.6 V and −0.6 V. Line 42 at 0 V represents the decision tress hold and the decision moments are again points 1, 2, 3 etc. The high/low decision of the receiver is thus based on the differential signal SC.

This signal is completely independent of the common mode voltage, i.e. the average data line voltage, in the receiver and thus not sensitive to the average current pulled through the pull-up resistors. Thus, when an equal current is drawn from each input of a differential pair (INn and INi in FIG. 5) and the resulting voltage is within the receiver common mode range, this current will not affect the receiver state. This current can be supplied to a powering circuit within an optical receiver that is connected to the differential input pair. The powering circuit is for example that of the optical receiver amplifier. This amplifier delivers then an output signal, for instance a differential signal current that usually is relative small. Additionally this current can be supplied to the electrical receiver input such that the receiver is able to receive the data signal.

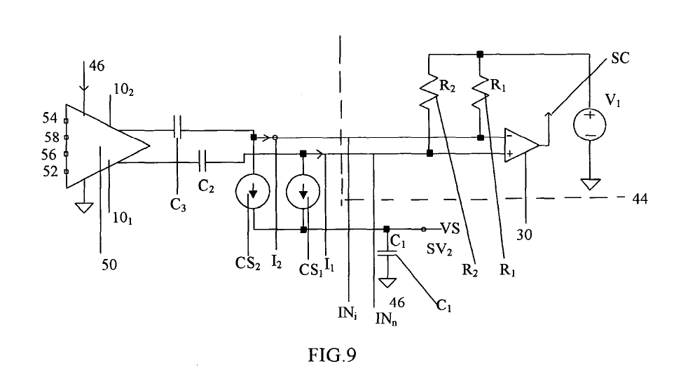

FIG. 9 shows an embodiment of a circuit for carrying out this process. The right hand portion, delineated by interrupted line 44, of this Figure shows the pull-up stage of the electrical receiver whilst the left-hand portion shows the output stage of the optical receiver. This circuit includes two current sources CS₁, CS₂ who pull a DC current I₁, I₂, respectively through pull-up resistor R₁ and R₂, respectively. The signal level at inputs INn and INi is low so that the voltage over R₁ and R₂ does not significantly drop below 3 V. Current sources CS₁ and CS₂ supply current to a voltage supply VS, which delivers a supply voltage SV₂ of 2.5 V. Preferably this voltage is filtered by means of a capacitor C₁ and then supplied to line drivers 10₁ and 10₂ of the optical receiver, as indicated by arrows 46. The line drivers are supplied via an amplifier 50, which is connected to the radiation-sensitive detector 4. Amplifier has for example four inputs 52, 54, 56 and 58, usually positive and negative inputs for a photo detector signal and for reference voltages for the amplifier. Instead of this amplifier many alternatives may be used to convert photo diode signals into a differential output signal. Line drivers 10₁ and 10₂ are coupled via capacitors C₂ and C₃, respectively to inputs INn and INi, respectively.

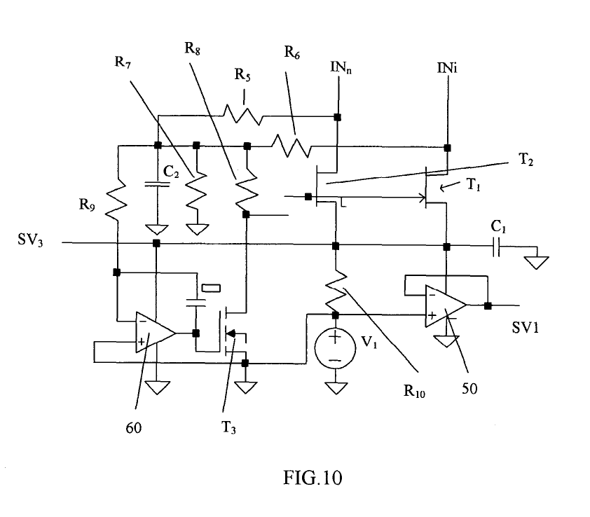

FIG. 10 shows an embodiment of an implementation of the current sources. The circuit of FIG. 10 comprises two transistors T₁, T₂, preferably field effect transistors (FET) and more preferably JFET's. Transistors T1 and T2 draw a current from the inputs INn and INi, respectively and are preferably identical. For that reason they are taken from one production batch or integrated on one chip. The circuit further includes a resistor divider comprising resistors R₅, R₆ and R₇ for monitoring the average voltage at inputs INn and INi and the monitored voltage is low-pass filtered by means of capacitor C₂. The average voltage is a known function of Vpu (in the electrical receiver) and the average current drawn from the inputs INn and INi. The average voltage is compared with the voltage of a reference voltage source V₁ in an operational amplifier 60, which, together with capacitor C₃ and resistor R₉ is used as an error integrator. The output of operational amplifier 50 drives a further transistor T₃, preferably a FET, which is pulled up by means of a resistor R₈. The value of R₂ is such high that the current through this resistor does not affect significally the voltage at capacitor C₂. The output signal of transistor T₃ is supplied to the gates of transistors T₁ and T₂ so that the current through these transistors is controlled. These currents will be equal if T₁ and T₂ are identical.

If the voltage at capacitor C2 is too high the output voltage of operational amplifier 50 will decrease and the current in transistor T₃ will decrease so that the gate voltages of transistors T₁ and T₂ will increase. This will result in a larger current drawn through the pull-up resistors R₁ en R₂ (FIGS. 1-4) in the electrical receiver and decreasing the voltage at capacitor C₂ to the desired level. This means that the desired current will flow through the pull-up resistors.

Preferably field effect transistors T1 and T2 are of the depletion type to allow use of a control voltage that is lower than the drain- and source voltages of these transistors. It is also possible to use a higher supply voltage, which can be obtained by means of up-conversion, such that higher gate voltages can be supplied to transistors T1 and T2, in particular if these are enhancement FETs.

The voltage SV₃ at which the current is supplied to the source input of transistors T₁, T₂ and T₃ is an intermediate voltage of, for example 2.7 V. This voltage is converted to a stabilized voltage of 2.5 V by means of operational amplifier 50 and the reference voltage V₁, which is 2.5 V in this embodiment. The current for the reference voltage source V₁ is supplied via resistor R₁₀. This reference may be constituted by a band gap reference typically used in ASICs to generate reference voltages, a Zener diode, an active reference voltage source named TL431 or another reference voltage source. Resistor R10 has such value that the total current consumption of the circuit is equal to the current drawn through pull-up resistors R₁, R₂ and that the correct voltage is obtained at line SV₃. In case the current consumption is not known, an additional component, for example a variable resistor or a field effect transistor may be used to put the voltage at line SV₃ at the desired level.

In case in a circuit similar to that of FIG. 10 a number of, for example four, differential input pairs INn, INi are used, this circuit will comprise a corresponding number of transistors T₁, T₂ and resistors R₅, R₆.

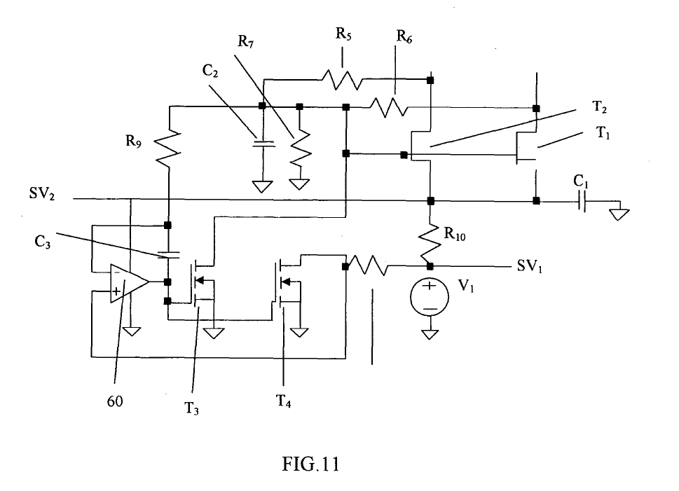

FIG. 11 shows another embodiment of the circuit. This embodiment differs from that of FIG. 10 in that resistor R₈ is omitted. As a consequence the voltage obtained from the resistor divider R₅/R₃/R₇/R₆ would be dependent on the current in transistor T₃. Therefor an additional transistor T₄, preferably a PET, is added which mirrors at least a fraction of the current in T₃ and accordingly adjusts the reference voltage V1 via a resistor R₁₁.

The invention is not limited to the embodiments shown in FIGS. 10 and 11. Several designs for the current sources and the power supply circuitry are possible, whereby these are preferably implemented as a fully integrated circuit.

A similar method as illustrated in FIGS. 5-8 may be used for single ended output(s), i.e. non-differential output(s), optical receivers and corresponding single ended input(s) electrical receivers, if the resistance of the pull-up resistors is small enough to drawn a current without disturbing a high level of the input.

However, in practice the input stage of the electrical receiver may comprise pull-up resistors of, for example 27 kOhm and a pull-up voltage of, for example 3V or 5 V. Often the signal level for such an input is high such that in the input's active, i.e. low-power, state the voltage may be nearly zero. Using the above-described method for powering the circuitry of such an optical receiver may cause problems, because the voltage may collapse. Also the large resistance value of the pull-up resistors as well as the fact that the input cannot be pulled too low without disturbing the high level of the input, may severely limit the current that can be drawn from such an input for the purpose of powering another circuitry. Thus under circumstances the available power may be insufficient for powering an optical receiver or an optical bi-directional receiver/transmitter.

According to the invention sufficient power for the required operation can still be provided if the duty cycle of active state versus non-active state is small. This can be realized by drawing a small current, i.e. a current that does not disturb the high level, from the input of the electrical receiver and storing this current in an energy saving component such as a battery or a capacitor to built up the required power. This power can then be used during the time that the optical receiver or bi-directional receiver/transmitter should be active.

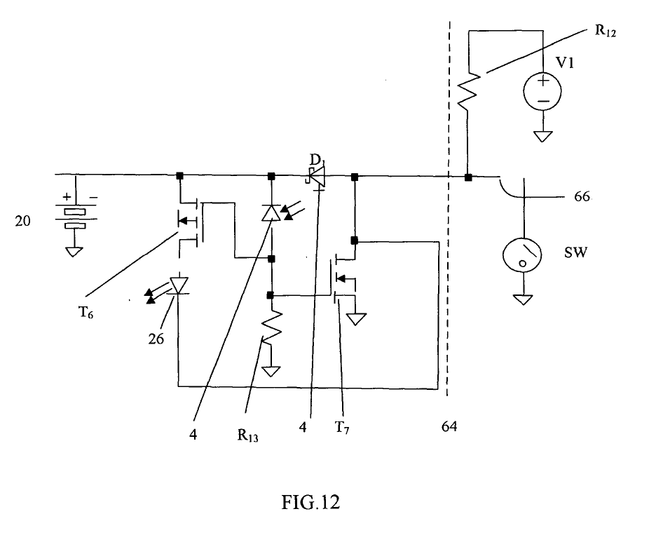

FIG. 12 shows an embodiment of a circuitry, which allows such operation. The optical receiver with power storage capability is shown at the left side of the interrupted line 64, whilst the apparatus including the electrical receiver is located at the right side of this line. Pull-up resistor R₁₂, for example of 27 kOhm, pulls data line 66 to a high state whenever this line is non-active. For some types of communication, such as remote control, this will be the case most of the time. When data line 66 is active an electronic switch SW, for example a controlled switch (CSW), a bipolar transistor or a FET, in the electrical receiver pulls the line in low state. The circuit comprises a diode D₁, which supplies a charge current to the energy saving component 20, for example a battery or capacitor, thereby loading this component to, for example 2.7 V. Preferably this diode is a Schottkey diode, because of its low voltage drop. The design is such that if the voltage of battery 20 is high enough and leakage is small, as is usually the case, the level of line 66 will not be pulled low enough to be interpreted by the electrical receiver as an active (low level) state. If necessary, a charge current limitation may be included in the circuit.

As soon as the optical detector 4, preferably a photodiode receives light, the voltage across resistor R₁₃ becomes high and transistor T₆, for example a pMOS field effect transistor shorts line 66 to ground. Thus illumination of detector 4 is communicated to the electrical receiver as data line 66 being in an active, low-level, state.

In case the fiber optical link is bi-directional and the optical receiver comprises a transmitting diode laser 26, a second field effect transistor T₇, preferably of nMOS type is included in the circuit. During the active state of line 66 the gate of transistor T₇ is also pulled high so that the current circuit for diode laser is interrupted so that this laser does not become active during the active state of line 66. As long as detector 4 does not receive light and switch SW is closed, i.e. line 66 is active and at low level, current flows through diode laser 26 so that it can send the message that the receiver at this side is in the active state (low level) in the reverse direction, thus towards the other end of the fiber optical link.

It will be clear that the energy saving component 20 is essential for this operation. Since the system, optical link and receiver, is most of the time inactive even a small charge current is sufficient to support operation when needed.

The mere function of FIG. 12 is to explain the use of an energy saving component in an optical receiver. It will be clear that an integrated, more complex, circuit allows performing more sophisticated operations with additional functions, such as ESD (electrostatic discharge) protection, laser current limitation or amplification, amplification of the optical detector output etc.

A 2-terminal device, such as a simple photo diode without amplification and/or signal processing, may be unsuitable because such device can be directly coupled to an electrical input having pull-up capability. However, the various embodiments of the devices described herein may be used, and may even be required, in optical receivers having a circuitry that needs supply voltage at a supply terminal and has at least one separate data signal input, as well as in optical receivers which include at least one optical transmitter having a supply voltage terminal separate from a signal terminal.

A practical example of a differential electrical input with low-impedance pull-up resistors, which allows drawing a constant current is a coupled (common) mode logic (CML) input that is used in a HDMI interface. This is a high-speed input suitable for the transmission-minimized data signaling (TMDS) standard for video and audio information. The current is supplied as long as the input is powered, which usually is the case when the sink, i.e. the electrical receiver or the apparatus including this receiver is active. When the input is sufficiently powered excess energy may be used to further charge the energy storage component 20 mentioned herein above.

A practical example of a single electrical input with a high-impedance pull-up resistor and having a low duty cycle operation is the consumer electronics control (CEC) connection in an HDMI interface, which CEC connection is used for remote control information. It is expected hat the pull-up voltage at a CEC input is high as long as the sink, in this case the circuitry connected to the CEC input, is powered and at least in a standby state.

Another example of a single electrical input having a low duty cycle of operation is an I²C input that is used to transfer digital transmission protocol (DDS) signals, typically including clock and data signals, from the sink, or receiving apparatus to the source apparatus in a HDMI interface. Possibly, this interface does not have an active supply voltage when the sink apparatus is on, i.e. active and thus it is not sure that an energy storage component can be charged. Another point is that transfer of DDS data in a HDMI interface is more complex than merely transferring CEC data, in particular when all data signals need to be multiplexed so that they can be transferred by means of one (bi-directional) optical channel. However use can be made of the fact that transfer of DDS data is required only at the moment that the receiving apparatus is ready to receive and process these data. This moment, herein after referred to as ‘ready’ moment, can be defined as the moment that the receiving apparatus has to be powered up and the differential inputs of the HDMI receiving apparatus have to become active. These inputs can supply enough power for both the high-speed optical receiver functions discussed at the hand of FIG. 2 and for processing the more complex DDS signal. The provision to send a signal from the receiving apparatus to the source apparatus at the moment that the two are coupled with each other, the so-called hot-plug detect feedback, can be adapted to do such at the ‘ready’ moment.

Alternatively, the DDS data could be made available when asked for and the power could be supplied by the energy storage component. However the hot plug detect feedback should then be present all the time, which would require additional power.

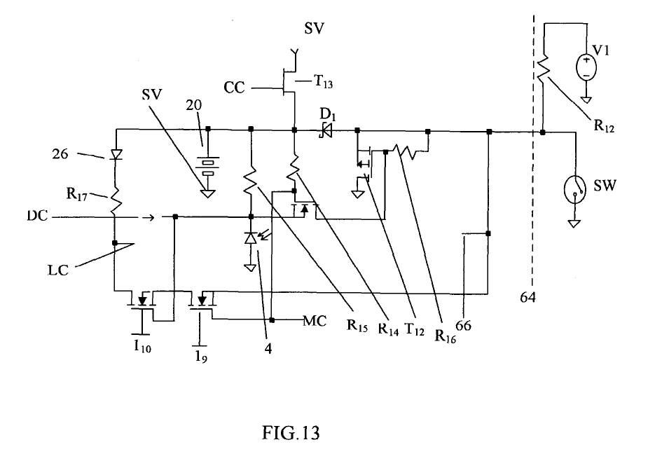

FIG. 13 shows an embodiment of a receiver circuit for use in a low-speed optical link that allows operation in both a basic mode and a higher-speed multiplexed mode. The circuit for the basic mode is similar to that discussed herein before, for example that of FIG. 12. Again the apparatus including the electrical receiver is located at the right side of interrupted line 64, whilst the opto-electronic device (the optical receiver) without power source is at the left side of this line. To the basic circuit are added the functions: interface mode control (MC), charge control (CC), laser control (LC), detector control DC and data DT. These are controlled by an additional logic circuit that can interface to other data channels such as a DDS data interface between the optical receiver and the electrical receiver.

If mode control MC is active its output will be low. When MC is passive, which generally will be the case if the said additional logic is powered down, the voltage at the MC output is pulled high by means of resistor R₁₄. Then field effect transistors T₉ and T₁₁, for example nMOS FET, are switched on and the output signal of optical detector 4 drives another field effect transistor T₁₂. When detector 4 receives light the data line 66 is pulled low. Also the gate voltage of field effect transistor T₁₀ is then low, which prevents the diode laser 26 from switching on. When detector 4 does not receive light and switch SW is closed transistors T₁₀ and T₁₁ are on and diode laser 26 is switched on. Thus the circuit performs the basic operation in such way that current consumption is very small, near zero, when the data line is not active.

When multiplexed data have to be transferred power from energy storage component 20 is used during a short period of time. Alternatively use can be made of another current source, for example current from the high-speed interface when this active. Then control input, or interface MC (mode control) is pulled low and interface DC is used to receive detector 4 signals to a logic circuit as shown in the optical receiver diagrams discussed herein above. Interface LC is used to drive diode laser 26 and interface DD is used to supply the electrical receiver with data. When an additional current source is available charge control CC, which uses a field effect transistor T₁₃ and receives supply voltage SV, for example 2.7 V from battery 20, can be set at a high level, which allows fast charging of the battery.

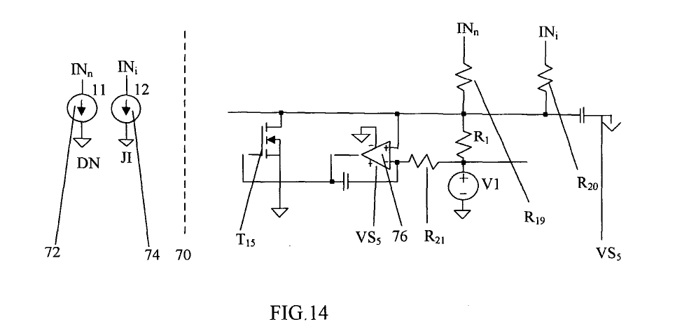

Draining power for a circuit of an optical receiver by means of current sources in the pull-up stage of the electrical receiver is just one of the possibilities. FIG. 14 shows an embodiment of an alternative one. The section at the left side of the vertical interrupted line 70 is part of the optical receiver and shows how modulation of the data signal is performed whilst the right hand section shows an energy draining and termination circuit. The latter circuit, the pull-up stage of a receiving apparatus, comprises two resistors R₁₉ and R₂₀, of for example 50 Ohm at the inputs INn and INi, respectively. Because of this type of input, the data output of the optical receiver should be of high impedance. This is realized by using current source 72 and 74. Current source 74 is the inverse of current source 72 so that the two form a current mirror. Current source supplies 4 mA when the data signal is high and 0 mA when the data signal is low.

A current of, for example 4 mA flows through resistors R₁₉ and R₂₀, which results in a supply voltage VS₅, for example 2.9 V at a capacitor C₅ and a voltage VS₆ at inputs INn and INi. of 3.1 V. When current, or data-, source 72 or 74 supplies current the voltage at input INn or INi decreases 100 mV to 3.0 V and the current through R₁₉ or R₂₀ decreases to 2 mA. Since either source 72 or source 74 is on the total current flowing to capacitor C₅ via resistors R₁₉ and R₂₀ is about 6 mA. To stabilize supply voltage VS₅, a feedback circuit is included that comprises operational amplifier 76, field effect transistor T₁₅ and reference voltage source V₁ of 2.5 V.

Between the design of FIG. 14 and the designs of the previous Figures a number of intermediate designs are possible. For instance, both the data output of the optical receiver and the energy draining section may have intermediate impedance. This means that none of them is a pure current source or a pure sink, or receiving apparatus, input. The intermediate impedance's can be chosen such that their combined parallel impedance constitutes a suitable termination of the data lines. The data current sources need not to terminate to ground. Because the voltage swing at their outputs is quite small, they may terminate into an intermediate voltage supply that is present for other circuitry. The current sources will then feed this intermediate voltage supply. The energy draining function and the data output function might also be combined in one circuit.

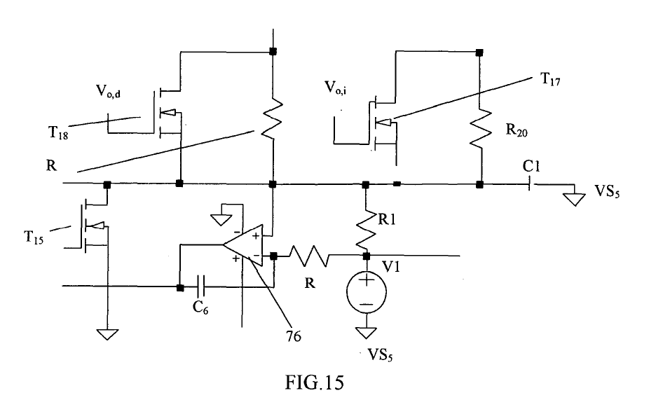

FIG. 15 shows an embodiment of such energy and termination circuit. This circuit differs from that shown in FIG. 14, in that field effect transistors T₁₇ and T₁₈ are arranged parallel to resistors R₂₀ and R₁₉, respectively. Transistor T₁₈ is driven by a combined offset voltage and a data signal Vo,d whilst transistor T₁₇ is driven by the combined offset voltage and inverse data signal Vo,i. The offset voltage determines the average current through transistors T₁₇ and T₁₈, whilst the data signal and inverse data signal determine which of the transistor currents is highest. Resistors R₂₀ and R₁₉ may have higher impedance value so that the parallel impedance of R₂₀ and R₁₉ present a suitable termination for the high-speed data lines INi and INn, respectively. The offset voltage is controlled or fixed such that a desired average current is obtained.

Under circumstances a high-impedance may be suitable for the low-current state of the FET and a low-impedance for its high-current state. In particular, if the apparatus including the electrical receiver presents a good termination for the transmission line, such as an IIDMI termination, no reflection of signals will occur upon connection of this apparatus to the INn and INi lines. Then, the behavior of the output, or termination-, impedance of this circuit is not critical so that R₂₀ and R₁₉ may have a large Ohm value. Preferably the field effect transistor are of depletion type so drive voltages lower than 2.9V or 2.5 V may be used.

With an IIDMI link, the transfer of data may be postponed until the high-speed data interface pull-up voltage is present. In a conventional, cable, HDMI link the data source, for instance a DVD player supplies a voltage of approximately +5 V to the data sink, or receiving apparatus, for example a video display such as an LCD. The receiving apparatus sends this +5 V back to the source via the ‘hot plug detect’ line at the moment it is ready to receive DDS data. In an optical link the data source includes an optical transmitter, which allows data to be sent to an optical receiver, which supplies the received data to the data sink. To report the transmitter that the receiver is ready to receive and process DDS data, the optical receiver is provided with a low-speed laser and the data source is provided with a low-speed data receiver for low-speed bi-directional optical communication via a low-speed optical link channel.

When DDS data is being transferred, the optical receiver's transmitter sends several signals, for instance DDS data, CEC data and hot plug detect signals to the transmitter side via the low-speed channel. On the other side the optical transmitter also sends to the optical receiver several signals, for instance a +5 V presence, DDS data, DDS clock and CEC data signals via the low-speed optical channel. All these signals need to be multiplexed processed, transmitted, received, de-multiplexed and processed and for all these process steps power is required. The optical receiver could receive this power from an energy storage device. However, the optical receiver may wait with reporting that it is ready for transfer of DDS data until the high-speed interface has acquired the pull-up voltage and power can be drained from it. This is in accordance with the fact that information cannot be displayed as long as the display has not been powered up.

As already remarked the receiver for an optical low-speed connection is suitable for a simple basic mode, wherein short bursts of CEC data are communicated, as well as for another mode, wherein data is multiplexed. In the CEC-only mode the optical link is passive most of the time. At the side of the optical transmitter (data source) the presence of CEC data may easily be detected so that a this side it can readily be determined if the optical receiver and the data sink (receiving apparatus) are ready to supply DDS data. Thus the conventional hot plug detect that has to be supplied to the data source is replaced by determining the state of the low-speed bi-directional optical channel. If this would be needed the optical receiver could internally generate a voltage of +5 V by means of up-conversion of an internal voltage. The optical transmitter has such a voltage already available for powering its electrical circuitry.

An all-optical link, i.e. a fiber optical link, between a data source and a data sink, such as a visual display with HDMI interface may be realized without an external bulky power supply at the display side. Preferably the optical receiver will be miniaturized and integrated in the HDMI connector. If the space behind a display is limited, the connector plug may be made pivotally and/or connected by means of a flexible cable to the optical receiver part of the connector.

It may be convenient for a user of a fiber optical link, for instance a HDMI link, to visually watch link activity, particularly for trouble shooting, but also for esthetic reasons. A visual indication of link activity can be realized by means of light emitting diodes (LED's), for in stance in a HDMI connector), which are controlled such that they will not needlessly drain an energy storage device. Alternatively, if a transparent fiber connection is used, visible laser radiation may be used to indicate some of the functions being performed, for example CEC and/or DDS information being transferred It is also possible to design the fiber or the fiber launch such that a fraction of the light propagating along the fiber can escape from the fiber to become visible. A further possibility is to use dedicated LED's to internally illuminate the fiber for indicating an activity. Thereby different colors may be used for different activities, for instance red light for basic low-speed operation with CEC only, green light for full low-speed operation (including DDS data transfer) and blue for full operation including high-speed data transfer. Many other combinations are possible.

In summary, an optical receiver may be powered by draining current that is flowing through pull-up resistors in an electrical receiver that is connected to the optical receiver. This concept can be realized in many ways and only a few embodiments have been described, although others will be readily apparent to those skilled in the art. A second aspect is the use of an energy storage component in case pull-up voltages are not continuously present or cannot supply sufficient power to instantaneously power the optical receiver. A third aspect, in particular for HDMI applications, is that transfer of DDS data is postponed until the moment a high-speed data interface pull-up voltage is present.

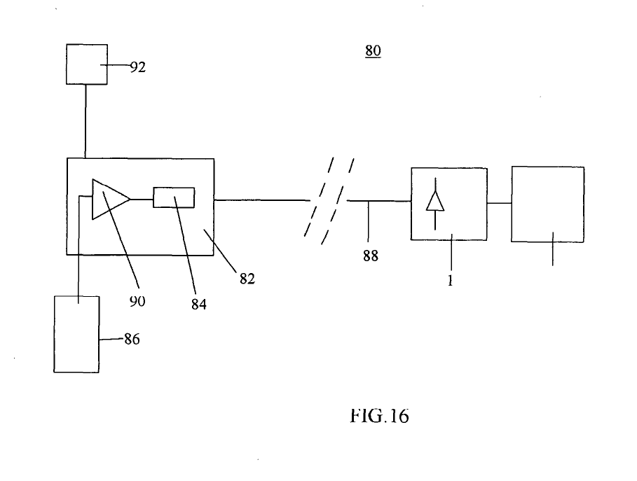

Providing a fiber optical link with a receiver as described herein may be advantageous to make optimum use of the capabilities of this link. FIG. 16 shows a principle diagram of the optical link 80, which is intended for data communication in, for example the gigabit (Gbs) range. The link includes an optical transmitter 82, which comprises a diode laser 84. The transmitter is powered from a voltage source 92. An optical fiber 88 is optically coupled to the radiation emitting face of the diode laser such that the input end of the fiber captures maximum laser radiation. The output end of the fiber is optically coupled to the optical receiver described herein before, which is composed of an optical receiver unit 1 and an electrical receiver unit 2. The latter unit forms part of a receiving apparatus for example a video display apparatus such as a LCD.

The transmitter 82 receives electrical data signals DS from a data source 86, which is an apparatus that includes a device for generating, receiving and processing digital signals. The data source may be a computer, a video signal generator, for example a DVD player, or any other digital data signal generator. The transmitter 82 includes a high-speed driver amplifier 90 for controlling laser 84 such that the radiation emitted by the laser is modulated in accordance with the data signal DS. For further details about the optical link reference is made to the patent application EP 07105438.1.

The power saving fiber optical link of EP 07105438.1 can be switched between a high-speed mode and a low-speed mode whereby in the low-speed control data are transferred. By using in such optical link the new receiver having a pull-up stage further power saving becomes possible. Transfer of control data can be delayed until the voltage of the pull-up stage is sufficient to supply the required power so that no other power source needs to be used.

This configuration of the fiber optical link that is suitable for bi-directional communication also allows using the voltage-state of the pull-up stage to control switching between the high-speed mode and the low-speed mode.

1. A receiver for optical signals, comprising an optical receiver unit (1) and an electrical receiver unit (2), which optical receiver unit comprises a radiation sensitive detector (4) for converting an optical signal (SO) into an electrical signal (Sd) and an electronic circuit (6, 8) for processing the electrical signal, characterized in that the optical receiver unit comprises a power draining circuit (16) that drains power from a pull-up stage (R1-R4; Vpu) of the electrical receiver and supplies power to the electrical circuit of the optical receiver unit.

2. A receiver as claimed in claim 1, characterized in that the electrical receiver unit (2) includes a first pull-up stage (R₁-R₄; Vpu) for high-speed signals and a second pull-up stage (R₅; Vpu₂) for low speed signals, both stages being coupled to the power draining circuit and comprising a voltage source and at least one pull-up resistor.

3. A receiver as claimed in claim 1, characterized in that the optical receiver unit comprises a power storage component (20), which receives a current (22) from the power draining circuit (16).

4. A receiver as claimed in claim 1, characterized in that the optical receiver unit comprises an additional radiation-sensitive detector (24) for low-speed signals and an associated electronic circuit (25) for processing low-speed signals, which is powered from the second pull-up stage R₅; Vpu₂).

5. A receiver as claimed in claim 1, suitable for bi-directional optical communication, characterized in that the optical receiver unit (1) comprises a radiation source (26) and associated electronics (25) that is powered from the power draining circuit (16).

6. A receiver as claimed in claim 1, wherein the optical receiver unit (1) includes line drivers circuitry (10₁, 10₂) for adapting the output signals, characterized in the power draining circuit (16) is integral part of the line driver circuitry.

7. A fiber optical link for transmitting digital data from a source apparatus (86) to a receiver apparatus, which link comprises an optical transmitter (82) coupled to the source apparatus (86) and a receiver (1,2) coupled to the receiver apparatus and at least one optical fiber (88) arranged between the two apparatuses, characterized in that the receiver is a receiver as claimed in any one of claims 1-6.

8. A fiber optical link as claimed in claim 7, characterized in that control means are provided for determining the state of the pull-up stage of the electrical receiver unit (2) and for delaying transfer of control data until the pull-up stage of the electrical receiver can supply sufficient power to the optical receiver unit (1).

9. A fiber optical link as claimed in claim 7, that is suitable for bi-directional communication and wherein the transmitter (82) and the receiver (1, 2) are designed to operate in a first, high-power/high-speed mode and in a second low-power/low-speed mode, characterized in that switching between the two modes is controlled by the voltage state of the pull-up stage.
